(19) United States
(12) Patent Application Publication
(10) Pub. No.: US 2021/0030102 A1
(43) Pub. Date: Feb. 4, 2021

(54) SHOE STRUCTURE

(71) Applicant: Qingyuan Global Technology Services Co., Ltd., Qingyuan City (CN)

(72) Inventor: YIH-PING LUH, Taipei City (TW)

(21) Appl. No.: 16/636,451

(22) PCT Filed: Aug. 3, 2018
(86) PCT No.: PCT/CN2018/098559

§ 371 Date: Feb. 25, 2020

(30) Foreign Application Priority Data
Aug. 4, 2017 (CN) 201710659986.7

(51) Int. Cl. A43B 3/00; F21V 33/00

(52) U.S. Cl. CPC A43B 3/001; F21W 2131/30; F21V 33/0004

(57) ABSTRACT

The present disclosure provides a shoe structure including a sole, an upper, and an auxiliary element. The sole has a first surface and a second surface opposite to the first surface. The first surface has a light source module. The upper has a light guide element. One end of the light guide element is disposed corresponding to the light source of the light source module. The light guide element has at least one bending point. The auxiliary element is disposed corresponding to the bending point.

### BACKGROUND OF THE INVENTION

### 1. Field of the Invention

The present disclosure relates to a shoe structure, in particular relates to a shoe structure having the function of projection.

### 2. Description of the Prior Art

A main function of traditional shoes is to protect people's feet. Along with technological advancement over time and the changes in people's demands, many types of shoes with a plurality of functions have been developed including leather shoes, sports shoes, sandals, slippers and high heels.

However, when people choose shoe products, in addition to considering the protection function of shoes, they pay more and more attention to the design, color, pattern, and auxiliary functions, making the appearance and functionality the most important factors in shoe selection and customer attraction. Therefore, multi-functional shoes with attractive appearance have been an indispensable accessory in the daily lives of modern people. However, limited by the material and functionality of shoes, it is difficult to have a breakthrough in their exterior design.

### SUMMARY OF THE INVENTION

In view of this, the present disclosure intends to provide a shoe structure, configured to project out a variety of patterns using optic fiber so as to provide a shoe structure having both an attractive appearance and high functionality.

A shoe structure includes a sole, an upper, and an auxiliary element. The sole has a first surface and a second surface opposite to the first surface. The first surface has a light source module. The upper has a light guide element. A first end of the light guide element is disposed corresponding to the light source of the light source module. The light guide element has at least one bending point. The auxiliary element is disposed corresponding to the bending point.

In an embodiment, the light guide element is selected from plastic fibers.

In an embodiment, the auxiliary element includes a pattern which is partially light-transparent.

In an embodiment, the pattern is projected out by the light traveling through the bending point.

In an embodiment, a projection angle of the patter may be adjusted by adjusting the auxiliary element.

In an embodiment, the light guide element further includes a cover disposed on two sides of the bending point.

Compared to traditional shoes, the shoes of the present disclosure may project out various types of patterns using fibers so as to provide a shoe having both an attractive appearance and high functionality.

### BRIEF DESCRIPTION OF THE DRAWINGS

FIG. 1A to FIG. 1C are diagrams illustrating a shoe structure in an embodiment of the present disclosure.

FIG. 2A and FIG. 2B are diagrams illustrating a shoe structure in another embodiment of the present disclosure.

FIG. 3 is a diagram illustrating a shoe structure in another embodiment of the present disclosure.

FIG. 4 is a diagram illustrating a shoe structure in another embodiment of the present disclosure.

FIG. 5 is a diagram illustrating a light guide element in another embodiment of the present disclosure.

### DETAILED DESCRIPTION OF THE PREFERRED EMBODIMENT

A plurality of embodiments of the present disclosure are disclosed in detail with reference to FIGs and sentences in the following paragraphs. In order to further understand the techniques of the present disclosure, a plurality of practical details are described together in the following paragraphs. However, it should be understood that these practical details are not intended to limit the scope of the present disclosure. In addition, for the purpose of clarification, some current structures and elements are illustrated simply in figures.

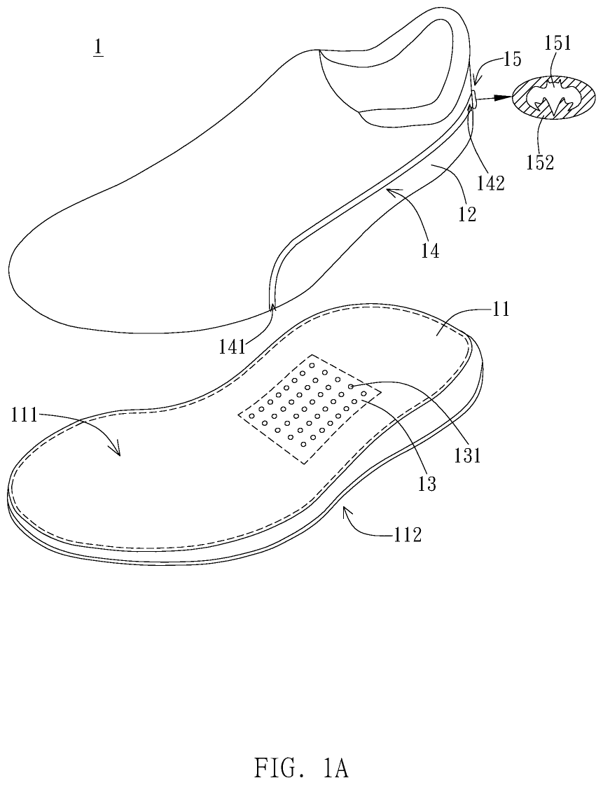

Please refer to FIG. 1A, and FIG. 1B. As shown in FIG. 1A, a shoe structure 1 includes a sole 11 and an upper 12. The sole 11 has a first surface 111 and a second surface 112 opposite to the first surface 111. The first surface 111 preferably has a light source module 13 thereon. The light source module 13 includes a power supply module and a plurality of light sources 131. The light sources 131 are preferably devices having high directivity such as light-emitting diodes (LED), laser diodes or other similar light-emitting elements. The power supply module may supply power using batteries, human power generation, or other power supply means, and there is no specific restriction.

The upper 12 includes a light guide element 14 which may be inserted in the upper 12 by weaving and may also be disposed on the upper 12 by insertion or other ways of fastening. In the present embodiment, the light guide element 14 uses a fiber, preferably a plastic fiber which is flexible. Wherein, a first end 141 of the light guide element 14 is preferably disposed corresponding to the light sources 131 of the light source module 13 so as to enhance the incident rate of the light. The light guide element 14 may be disposed on any one portion of the upper 12. The present embodiment uses only one light guide element 14 as an example, but not limited thereto.

An auxiliary element 15 is disposed on a second end 142 (the other end opposite to the corresponded light source) of the light guide element 14, which preferably uses a sticker with waterproof function but not limited thereto, and is preferably restickable. The auxiliary element 15 has a pattern, wherein the pattern has a light-transparent portion 151 and a light-tight portion 152. The light enters the light guide element 14 from the first end and goes out from the second end 142 by total internal reflection, so that the light irradiates the auxiliary element 15 and projects out the pattern corresponding to the auxiliary element 15.

As shown in FIG. 10, the light emitted by the light source may be transmitted through the light guide element 14 and irradiates the auxiliary element 15 to project out the pattern 15′. A light-transparent portion of the pattern may allow the light to travel through so as to form the corresponding contour. In the present embodiment, the pattern of the auxiliary element 15 is projected on the ground by the light source, and the pattern 15′ projected out will be slightly larger than the original pattern of the auxiliary element 15 due to the scattering of the light. The light-transparent portion 151 in the original pattern is projected out to form a pattern 151′, and the light-tight portion 152 in the original pattern is projected out to form a pattern 152′, so as to project out the pattern 15′.

In the present embodiment, the auxiliary element 15 is configured to be projected on the ground by adjusting an attachment angle of the auxiliary element 15 and using the principle of light scattering. However, in another embodiment, the projection angle of the pattern may be adjusted by adjusting the location and angle of the auxiliary element 15. It should be noted that the pattern in the present embodiment is merely used as an example, and not limited thereto.

In another embodiment, converging lenses and other similar elements may be optionally added on the auxiliary element 15 so as to enlarge the projected pattern.

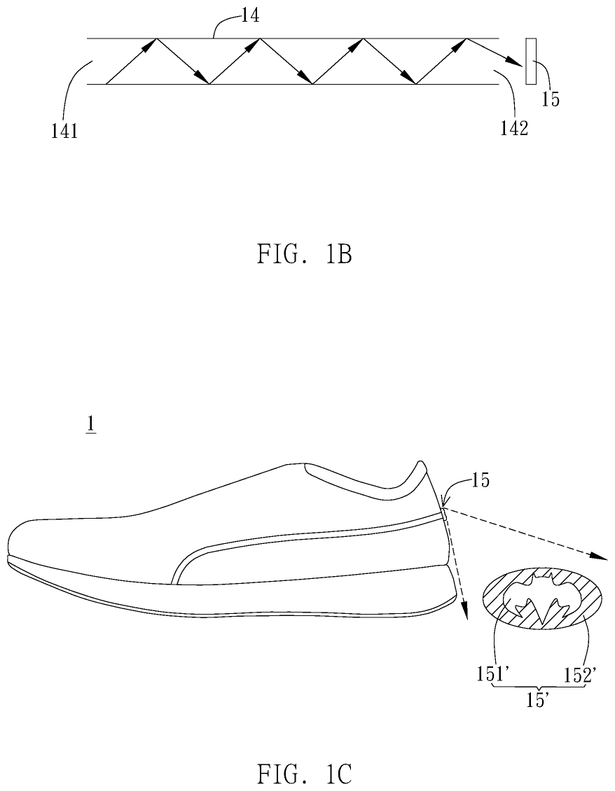

Regarding another embodiment of the present disclosure, please refer to FIG. 2A and FIG. 2B. The auxiliary element 15 is disposed on a bending point 143 of the light guide element. The bending point may be single or multiple, and there is no specific restriction. Its working principle is the following: A light travels through the light guide element 14 by total internal reflection, and the total internal reflection is destroyed by the bending point 143, resulting in a portion of the light scattered by the bending point 143. The light scattered by the bending point 143 irradiates the auxiliary element 15 and projects out a larger pattern 15′. The light guide element 14 in the present embodiment may be inserted in the upper 12 by weaving or other similar ways.

It should be noted that the light guide element 14 in FIG. 2B is a partial enlargement of the light guide element 14 in FIG. 2A. It should also be noted that the bending point 143 will not appear in FIG. 2A in the actual application.

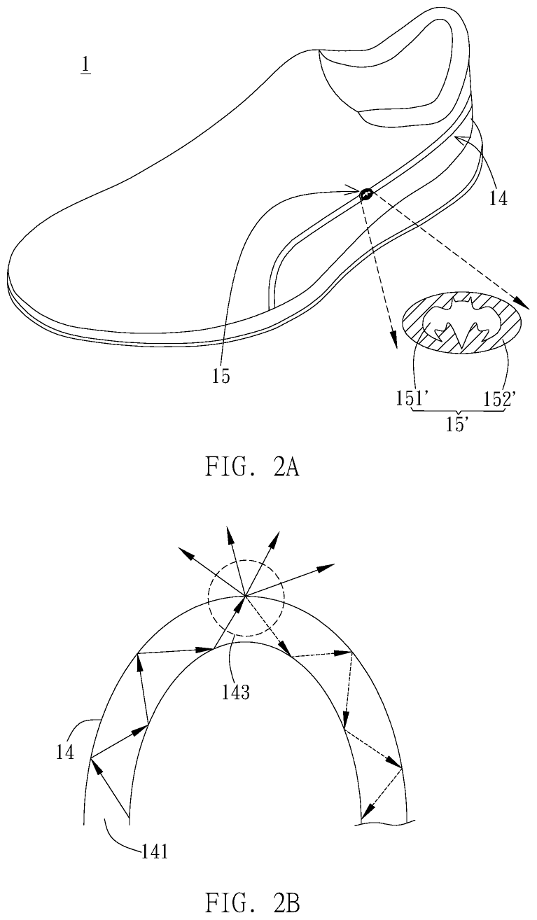

As in the aforementioned embodiment, the location of the projection may be adjusted by adjusting way of attachment of the auxiliary element 15, and the projection is not limited to being projected to the ground. In another embodiment, the pattern may also be projected out toward different directions such as sideward (for example, the pattern on the inner surface of the left shoe may be projected on the inner surface of the right shoe; the pattern on the outer surface of the left shoe may be projected on the wall close to the outer surface of right shoe; the patterns in the inner surfaces of both the left and right shoes may be projected out to each other), forward, and backward (please refer to FIG. 3).

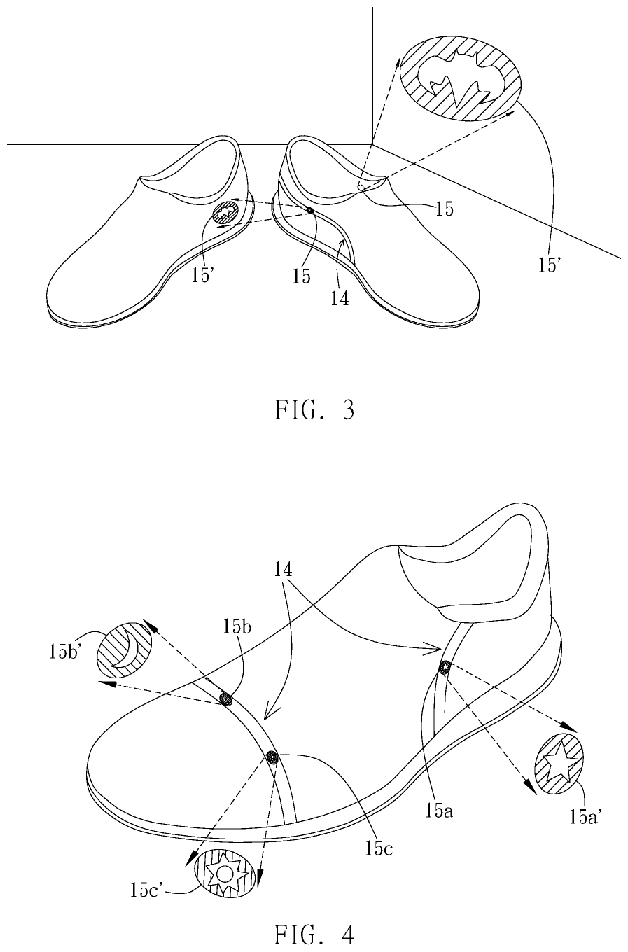

It should be noted that since the light guide element might have a plurality of bending points, in an embodiment, same or different auxiliary elements such as auxiliary elements 15a, 15b, and 15c may be disposed on each of the bending points respectively, so as to project out more diverse patterns such as patterns 15a′, 15b′, 15c′ to enhance the variation and the entertaining nature (please refer to FIG. 4).

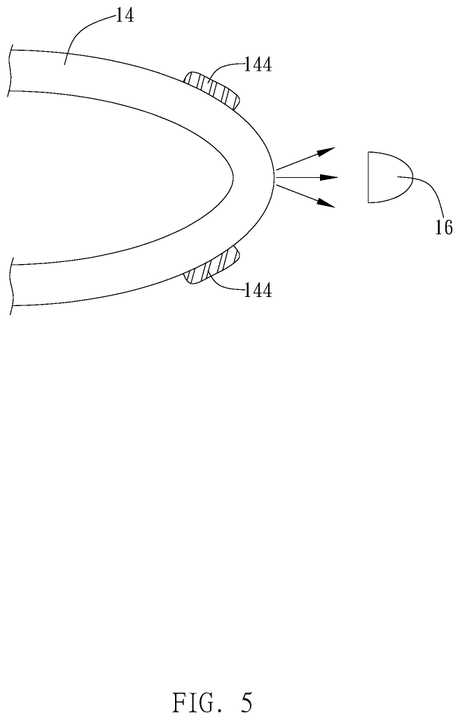

In another embodiment, a cover 144 may be disposed on two sides of the bending point 143 of the light guide element 14 for the purpose of blocking the scattered light on the side using the cover 14 so that the light exiting from the bending point 143 may be projected out to form a contour 16 whose shape is similar to a bulb (please refer to FIG. 5).

Compared to traditional shoes, the shoes of the present disclosure may project out various types of patterns using fibers so as to provide a shoe having both an attractive appearance and high functionality.

Exemplary embodiments are described in order to further understand features and concepts of the present disclosure, and do not have any intention to limit the scope of the present disclosure. On the contrary, various equivalent changes, alternations, or modifications are consequently viewed as being embraced by the scope of the present disclosure. Therefore, the scope of the present disclosure should be interrupted widely based on the aforementioned descriptions so as to cover all various equivalent changes, alternations, or modifications based on the claim of the present disclosure.

What is claimed is:

1. A shoe structure, comprising:
a sole having a first surface and a second surface opposite to the first surface, the first surface having a light source module;
an upper having at least one light guide element, a first end of the at least one light guide element disposed corresponding to at least one light source of the light source module, and the at least one light guide element having at least one bending point; and
at least one auxiliary element disposed corresponding to the least one bending point.

2. The shoe structure according to claim 1, wherein the at least one light guide element is selected from plastic fibers.

3. The shoe structure according to claim 1, wherein the at least one auxiliary element has a pattern, and the pattern is at least partially light-transparent.

4. The shoe structure according to claim 3, wherein the pattern is projected out by a light traveling through the bending point.

5. The shoe structure according to claim 4, wherein a projection angle of the pattern is adjusted by adjusting the auxiliary element.

6. The shoe structure according to claim 1, wherein the at least one light guide element further includes a cover disposed on two sides of the bending point.
